(19) United States
(12) Patent Application Publication
(10) Pub. No.: US 2011/0102854 A1
(43) Pub. Date: May 5, 2011

(54) IMAGE PROVIDING SYSTEM AND METHOD

(75) Inventors: Hyung-rae Cho, Seoul (KR); Sun-ae Kim, Seoul (KR); Hyun-joo Oh, Seoul (KR); Ji-young Kwahk, Seongnam-si (KR)

(73) Assignee: Samsung Electronics Co., Ltd., Suwon-si (KR)

(21) Appl. No.: 12/916,001

(22) Filed: Oct. 29, 2010

(30) Foreign Application Priority Data
Oct. 30, 2009 (KR) 10-2009-0104008

(51) Int. Cl. G06F 15/16; H04Q 5/22; G06K 9/00; H04N 1/00

(52) U.S. Cl. 358/403; 709/219; 340/10.1; 382/118

(57) ABSTRACT

Disclosed are an image-providing system and an image-providing method, the image-providing system to provide an image to a mobile terminal, the system including at least one image acquisition device including an identification unit which detects identification information to identify a user and an image pickup unit which takes an image including the user corresponding to the detected identification information when the identification unit detects the identification information; and a server which transmits the image taken by the image acquisition device to the mobile terminal based on predetermined transmission information.

### PRIORITY

This application claims priority to Korean Patent Application No. 10-2009-0104008, filed on Oct. 30, 2009 in the Korean Intellectual Property Office, the entire disclosure of which is incorporated herein by reference.

### BACKGROUND OF THE INVENTION

1. Field of the Invention

Apparatuses and methods consistent with the embodiments of the present invention relate to an image-providing system and an image-providing method, and more particularly, to an image-providing system which provides an image to a mobile terminal and an image-providing method of the same.

2. Description of the Related Art

A theme park or an amusement park, which includes rides, provides an attractive environment to take pictures. Generally, users carry a means of taking images such as a camera and take photographs using such means.

Further users' pictures may be taken in rides and provided to users. However, such images may not be edited by users, even though users may wish to edit them.

Images taken by a camera or the like may be stored in a digital medium such as a computer. However, the user does nothing but take an image.

### SUMMARY OF THE INVENTION

Accordingly, embodiments of the present invention provide an image-providing system, which easily provides images to a user who does not carry a image pickup device such as a camera and an image-providing method of the same.

The embodiments include an image-providing system, which takes dynamic images and provides the images to a user and an image-providing method of the same.

The embodiments also include an image-providing system, which takes images and provides edited images to a user and an image-providing method of the same.

The embodiments further include an image-providing system, which quickly provides taken images as a print to a user and an image-providing method of the same

According to an embodiment of the present invention, an image-providing system to provide an image to a mobile terminal, includes at least one image acquisition device comprising an identification unit which detects identification information to identify a user and an image pickup unit which takes an image including the user corresponding to the detected identification information when the identification unit detects the identification information; and a server which transmits the image taken by the image acquisition device to the mobile terminal based on predetermined transmission information.

The image acquisition device further includes a storage unit, which stores the transmission information matching the identification information and a communication unit, which transmits the taken image and the transmission information to the server.

The image acquisition device further includes a communication unit, which communicates with the server, and the image pickup unit takes an image of a user when transmission information matching the detected identification information is received from the server.

The image acquisition device further includes a user interface, which receives a user input signal, and the transmission information is received through the user interface.

The image acquisition device further includes a display unit, which displays an image to be taken, and the image acquisition device further comprises a user interface which selects an image to be taken.

The server further includes an image processing unit, which processes a stored image corresponding to an editing signal, when the editing signal to edit an image transmitted to the mobile terminal is received from the mobile terminal; and a storage unit which stores the processed image.

According to another embodiment of the present invention, an image-providing method of an image-providing system which includes an image acquisition device and provides an image to a mobile terminal is provided, the method including detecting identification information to identify a user by the image acquisition device; taking an image including the user corresponding to the detected identification information; and transmitting the taken image to the mobile terminal based on predetermined transmission information.

The image-providing method further includes storing transmission information about the mobile terminal, wherein the taking the image including the user is performed when the identification information corresponds to the transmission information.

The image-providing method further includes storing transmission information about the mobile terminal, wherein the transmitting the image to the mobile terminal is performed when the identification information corresponds to the transmission information.

The image-providing method further includes receiving an editing signal to edit an image transmitted to the mobile terminal from the mobile terminal; processing the taken image corresponding to the editing signal; and storing the processed image.

The image-providing method further includes transmitting the stored image to at least one of the mobile terminal transmitting the editing signal and a predetermined personal terminal.

The image-providing method further includes printing the stored image.

The image-providing method further includes printing the taken image.

According to another embodiment of the present invention, an image-providing system which includes a first device and a second device and provides an image to a mobile terminal is provided. The system includes the first device having a storage unit which stores authentication information about at least one mobile terminal; a sensing unit which detects a mobile terminal existing within a predetermined distance; an image pickup unit which takes an image; a first communication unit which transmits the taken image; and a controller which controls the image pickup unit to take an image of a user of the detected mobile terminal, and controls the first communication unit to transmit the taken image to the mobile terminal of the user based on the authentication information and to output a selected image to the second device when an image selection signal to select the image transmitted from the mobile terminal is received, the second device includes a second communication unit which receives the taken image; and an album generation unit which generates an album of an image received through the second communication unit.

According to another embodiment of the present invention, an image-providing method of an image-providing system which provides an image to a mobile terminal is provided. The method includes storing authentication information about the mobile terminal; detecting a mobile terminal existing within a predetermined distance; taking an image of a user of the detected mobile terminal; transmitting the taken image to the mobile terminal of the user; receiving an image selection signal to select an image transmitted from the mobile terminal; and generating an album of the selected image based on the image selection signal.

### BRIEF DESCRIPTION OF THE DRAWINGS

The above and/or other aspects will become apparent and more readily appreciated from the following description of the embodiments, taken in conjunction with the accompanying drawings, in which:

FIG. 1 is a schematic view of an image-providing system according to an embodiment of the present invention;

FIG. 2 is a block diagram of the image-providing system of FIG. 1;

FIG. 3 is a flowchart illustrating an image-providing method of the image-providing system of FIG. 1;

FIG. 4 is a schematic view of an image-providing system according to another embodiment of the present invention;

FIG. 5 is a block diagram of the image-providing system of FIG. 4;

FIG. 6 is flowchart illustrating an image-providing method of the image-providing system of FIG. 4;

FIG. 7 is a block diagram of a server and a schematic view of a mobile terminal according to an embodiment of the present invention;

FIG. 8 is a flowchart illustrating an image-providing method of an image-providing system including the server of FIG. 7;

FIG. 9 is a block diagram of a server according to another embodiment of the present invention;

FIG. 10 is a flowchart illustrating an image-providing method of an image-providing system including the server of FIG. 9;

FIG. 11 is a block diagram of an image-providing system according to still another embodiment of the present invention; and

FIG. 12 is a flowchart illustrating an image-providing method of the image-providing system of FIG. 11.

### DETAILED DESCRIPTION OF THE EMBODIMENTS OF THE PRESENT INVENTION

Embodiments of the present invention will be described in detail with reference to accompanying drawings. The embodiments may be embodied in various forms without being limited to the embodiments set forth herein. Descriptions of well-known parts are omitted for clarity, and like reference numerals refer to like elements throughout.

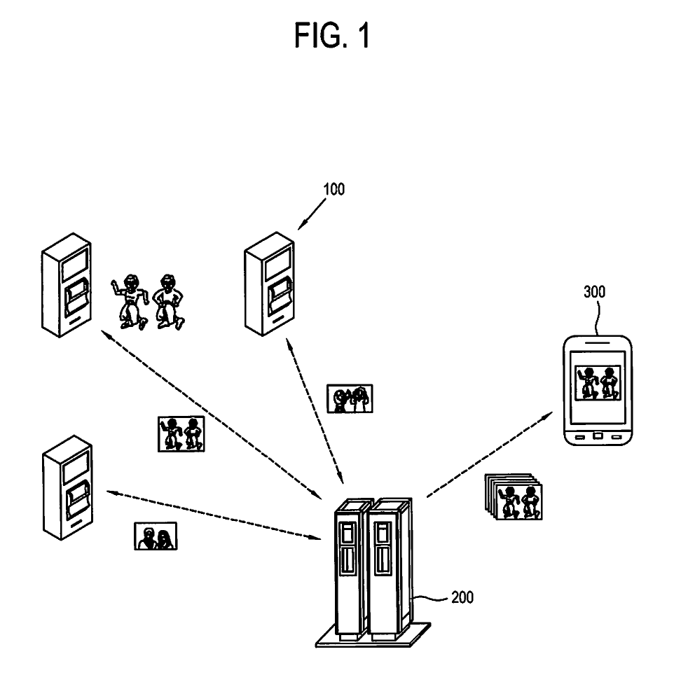

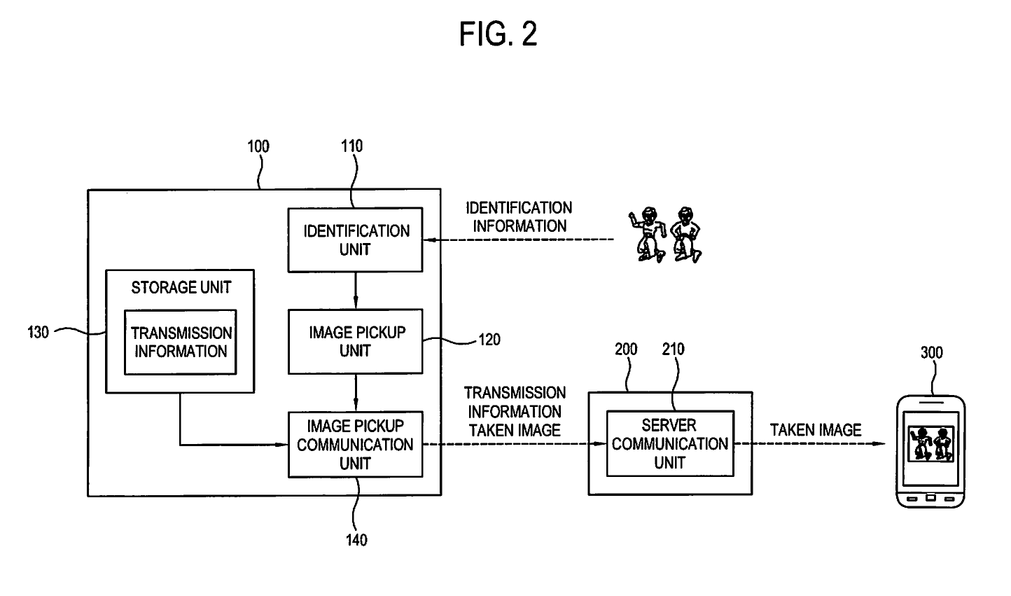

FIG. 1 is a schematic view of an image-providing system according to an embodiment of the present invention, and FIG. 2 is a block diagram of the image-providing system of FIG. 1.

As shown in FIGS. 1 and 2, the image-providing system includes an image acquisition device 100 to take an image and a server 200 to provide an image obtained by the image acquisition device 100 to a mobile terminal. The image-providing system, according to the present embodiment, includes the image acquisition device 100 provided in a particular place such as an amusement park which has rides, a park, an exhibition hall, an event hall, and the like and provides an image taken in the place to a mobile terminal 300 of a user. Hereinafter, description will be made with an image-providing system provided in an amusement park as illustrative example.

At least one or a plurality of image acquisition devices 100 may be provided. The image acquisition device 100 includes an image pickup unit 120 to take an image of a user. Further, the image acquisition device 100 further includes an identification unit 110 to detect identification information, a storage unit 130 to store transmission information, and an image pickup communication unit 140 to transmit a pick-up image to the server 200. The image acquisition device 100 may be installed at a plurality of points in the amusement park, particularly scenic spots, points where character figures are installed, places where many users take pictures, and points where dynamic images of users on rides can be taken, and the like. The image acquisition device 100 may include a movable camera and may be installed in a booth in a form of a vending machine as shown in FIG. 1.

The identification unit 110 detects or receives identification information to identify a user. The user may keep or carry a medium including identification information. The identification information may be a password included in a Radio-Frequency Identification (RFID) tag. The identification unit 110 may be embodies in an RFID communication unit, that is, an RFID reader. The identification unit 110 and the RFID tag may communicate using a passive communication scheme, in which only power of the RFID reader is used for reading information of the RFID tag and communication, an active communication scheme in which power of the RFID tag is used to transmit information, and a semi-passive communication scheme in which power of the RFID tag is used to read information and power of the RFID reader is used for communication. Specifically, a user may mount the RFID tag to a mobile terminal, a cellular phone or various digital devices, or attach the RFID tag to a wristlet worn on a body as a sign of an amusement park ticket when entering the amusement park. When the user moves around in the amusement park, the image acquisition device 100 automatically detects or receives identification information, which the user keeps through the identification unit 110.

The identification information may also be unique information of the mobile terminal 300 which a user carries. That is, the identification unit 110 detects the mobile terminal 300 within a predetermined distance and receives the information from the mobile terminal 300. Here, the identification unit 110 identifies the user through the mobile terminal 300, which the user carries. When the information of the mobile terminal 300 is the identification information, the identification information may include transmission information described below or be the same as transmission information described below.

According to another embodiment, the identification information is not a password included in an RFID tag or information about a terminal but an image of a user itself. That is, when advance information about the face of the user is stored in the image acquisition device 100, the image acquisition device 100 analyzes an image of the user input to the image pickup unit 120 to identify the user. Here, the image acquisition device 100 may identify the user through face recognition technology and image processing and an image-processing unit (not shown) to process an image input to the image pickup unit 120 may be an identification unit 110.

The image pickup unit 120 takes an image of a user corresponding to identification information when the identification unit 110 detects or receives the identification information. The image pickup unit 120 may take an image a moving user or a user who is posed or stands still. Thus, the image pickup unit 120 takes an image of the user using face recognition technology in order to obtain a clear image by recognizing a face of the user as precisely as possible. The image pickup unit 120 may zoom in and out in order to take an optimal image and adjust the shutter speed to take a plurality of images for a predetermined period of time. An image taken by the image pickup unit 120 may include a still image such as a photograph and a moving image. When a moving image is taken, content transmitted from the image acquisition device 100 to the server 200 and then from the server 200 to the mobile terminal 300 may include sound.

The storage unit 130 stores transmission information matching identification information. The transmission information denotes information of the mobile terminal 300 to transmit an image and matches the identification information one to one. When the mobile terminal 300 is embodies in a cellular phone, the transmission information may include a media access control (MAC) address to identify the cellular phone. The transmission information may be transmitted to the image acquisition device 100 through a communication network such as a wireless Internet, a wireless local area network (LAN), an RFID communication, and the like and may be registered in the storage unit 130 by a user inputting a telephone number of the mobile terminal 300 to the image acquisition device 100. The transmission information may be the same as or different from the identification information or be included in the identification information. The user may store or register the transmission information in the storage unit 130 in advance in order to be provided with an image to the mobile terminal 300. The identification information to identify the user may be generated simultaneously with the transmission information to identify the mobile terminal 300 and stored in the image acquisition device 100.

In another embodiment, the transmission information may be stored in the server 200 and then transmitted to the image acquisition unit 100 based on a request by the image acquisition device 100. Alternatively, the image pickup unit 120 may take an image of only a user registered in the storage unit 130 or the server 200 among detected users.

When identification information of a user is detected by the identification unit 110, the image pickup communication unit 140 may identify whether transmission information of the user exists in the storage unit 130 and take an image. Instead, when a user is detected, the image pickup communication unit 140 communicates with the server 200 to receive transmission information matching detected identification information. When the transmission information matching the identification information exists, the image pickup unit 120 takes an image of the user and transmits the image to the server 200. However, when the transmission information matching the identification information does not exist or the transmission information has an error, the image pickup unit 120 may not take an image of the user. When the image of the user is not transmitted, a data load due to transmission of an image is reduced and unnecessary transmission of data is prevented. As a result a transmission speed of data overall in the image-providing system is improved.

The image pickup communication unit 140 transmits a taken image to a server communication unit 210 of the server 200. In the present embodiment, the image acquisition device 100 and the server 200 transmit and receive various information and images using a wireless communication scheme. Wireless communication may be performed by using various known communication standards and be set so that the speed and frequency band may be adjusted depending on a size of a transmitted image.

Alternatively, the image acquisition device 100 and the server 200 may be connected to each other through a wire-based network or be connected directly to each other through a cable. Here, the image pickup communication unit 130 and the server communication unit 210 may be embodies in a cable and a connector, which connect devices, as a flexible film or a connector which connects boards.

The server 200 transmits an image transmitted from the image acquisition device 100 to the mobile terminal 300 of a user based on predetermined transmission information. The server 200 includes the server communication unit 210 to communicate with the image acquisition device 100 and the mobile terminal 300.

The server 200 transmits a taken image to the mobile terminal 300 of the user using transmission information received from or stored in the image acquisition device 100. The server 200 may store the transmitted image in a storage unit (not shown) and may transmit the image back to the mobile terminal 300 based on a request of the user.

When the server 200 stores transmission information, the server 200 may transmit the stored transmission information to the image acquisition device 100 or inform the image acquisition device 100 whether transmission information matching identification information exists when receiving a request for identification of whether the transmission information corresponding to the identification information exists from the image acquisition device 100.

The image-providing system according to the present embodiment is provided with the image acquisition devices 100 being installed at a plurality of spots in a limited space such as an amusement park and takes an image of a user by identifying the user passing by a space within a predetermined range from the image acquisition device 100. The taken image is transmitted to the mobile terminal 300 of the user, and, thus, the user may easily obtain the image even when the user does not carry a camera. Further, as the image pickup unit 120 may be installed in a position in which it is hard for the user to take an image, for example, in a ride (roller coaster), positioned in a place distant from the ground, the user may be provided with various and lively images.

The server 200 may transmit only an image having clarity of a predetermined critical degree or more to the mobile terminal 300 among images transmitted from the image acquisition device 100. An image in which the user is not recognized due to motion of the user, a image which is too dark, or an image having serious blur may not be provided to the user. The critical degree may be adjusted by the server 200 or set by the user to be provided with an image.

According to another embodiment, the image acquisition device 100 may further include a user interface to enable a user to select an image to be taken. The user may pose in front of the image pickup unit 120 of the image acquisition device 100 or direct an image, which the user desires.

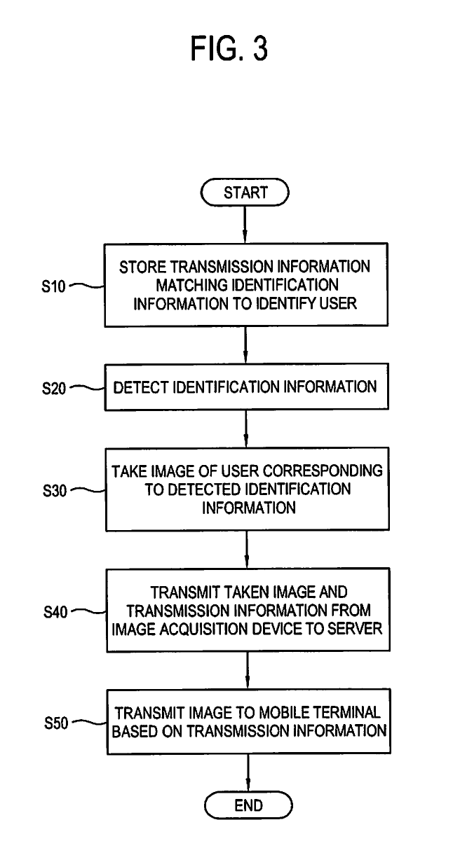

FIG. 3 is a flowchart illustrating an image-providing method of the image-providing system of FIG. 1. Hereinafter, the image-providing method according to the present embodiment is described with reference to FIG. 3.

First, a user stores or registers transmission information corresponding to identification information to identify the user in the image acquisition device 100 in step S10. The transmission information and the identification information may be generated simultaneously or sequentially.

The image acquisition device 100 detects or receives the identification information from the user within a predetermined distance in step S20. The identification information may be included in the mobile terminal, which the user carries or on a wristlet for an amusement park ticket. When the identification unit 110 detects the identification information, the image pickup unit 120 takes an image of the user corresponding to the identification information in step S30. The image pickup unit 120 may take an image of a face of the user as precisely as possible through face recognition technology. Also, the image pickup unit 120 takes an image of the user according to various algorithms with respect to backgrounds, positions of the user, and distance.

The taken image and the transmission information are transmitted from the image acquisition device 100 to the server 200 in step S40. The image acquisition device 100 and the server 200 may communicate with each other via a cable or wirelessly. In the present embodiment, the image acquisition device 100 and the server 200 transmit the image and the identification information via a wireless communication.

The server 200 transmits the received image to the mobile terminal 300 based on the transmission information in step S50. Instead, the server 200 may additionally or only transmit the image to a predetermined personal terminal (not shown), not to the mobile terminal 300. For example, the server 200 may transmit the image to a personal computer or notebook preset by the server 200. The taken image may be transmitted to a desktop computer in a user's home depending on a user's preference.

Alternatively, not the server 200 but the image acquisition device 100 may transmit the taken image to the mobile terminal 300. Either the server 200 or the image acquisition device 100, which transmits the taken image to the mobile terminal 300, may be changed based on a data transmission speed and a data transmission environment.

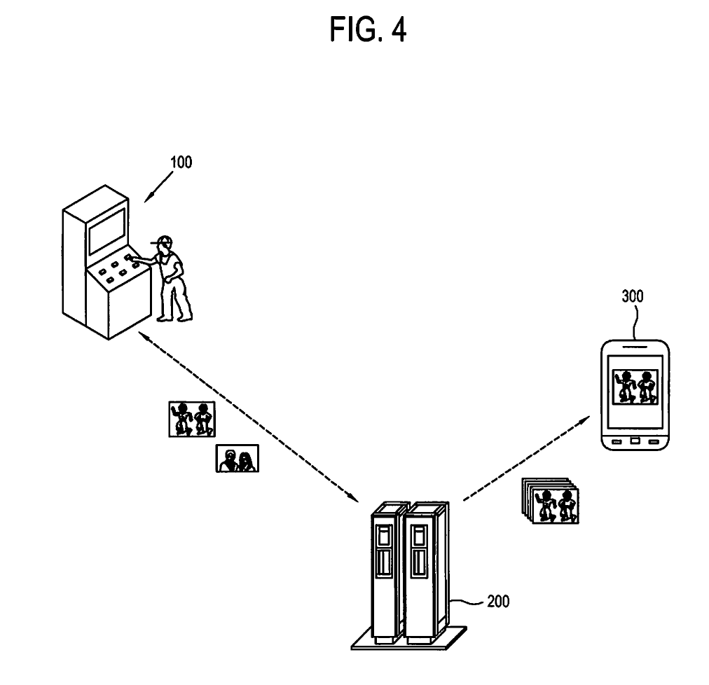

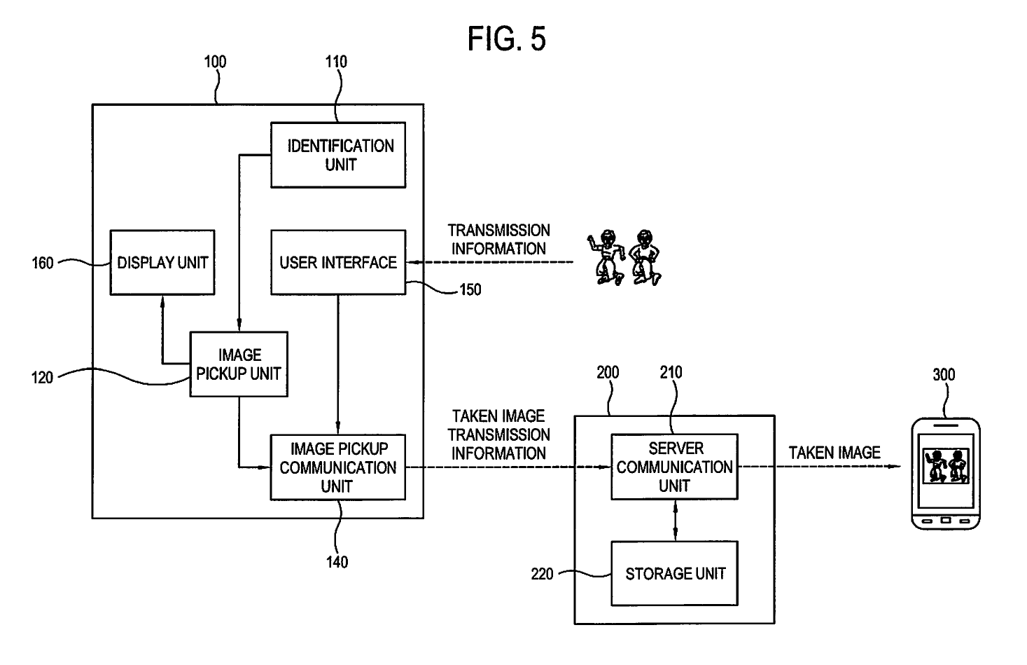

FIG. 4 is a schematic view of an image-providing system according to another embodiment, and FIG. 5 is a block diagram of the image-providing system of FIG. 4. As shown in FIGS. 4 and 5, the image-providing system includes an image acquisition device 100, including a user interface 150 and a display unit 160. The image acquisition device 100 is provided in the form of a booth in a predetermined spot. The same components as those in the above embodiment are not repeatedly described.

The user interface 150 may be embodied in an input unit including number keys and direction keys or as a touch panel providing a Graphical User Interface (GUI) to lead a user to an input. The display unit 160 displays an image to be taken and may include various panels and a panel driver to drive the panels. When the user interface 150 is provided as a touch panel, the user interface 150 may be mounted on an inside or an outside of the display unit 160 to be embodies in a single body with the display panel 160.

The image acquisition device 100 according to the present embodiment may be input with transmission information directly from a user through the user interface 150, shown in FIG. 4. Also, before or after taking an image, a user may input transmission information about a mobile terminal 300 to receive the image to the image acquisition device 100 using the user interface 150. Additionally, a user may select a taken image in person while viewing the image displayed on the display unit 160. That is, the image may be taken automatically by an identification unit 100, or an image desired by the user may be selected by the user.

An image pickup communication unit 140 transmits a taken image and input transmission information to a server 200, and the server 200 stores an image and transmission information in a storage unit 220.

The server 200 may transmit the transmitted image to the mobile terminal 300 in real time based on transmission information or may transmit images at once when a user desires to receive the images when the user exits an amusement park, for example. In order to easily transmit a plurality of images at one time, the server 200 may store taken images classified by transmission information.

In the present embodiment, a user may take a desired image in person using the image acquisition device 100 installed in the amusement park or may receive only desired images through the mobile terminal 300.

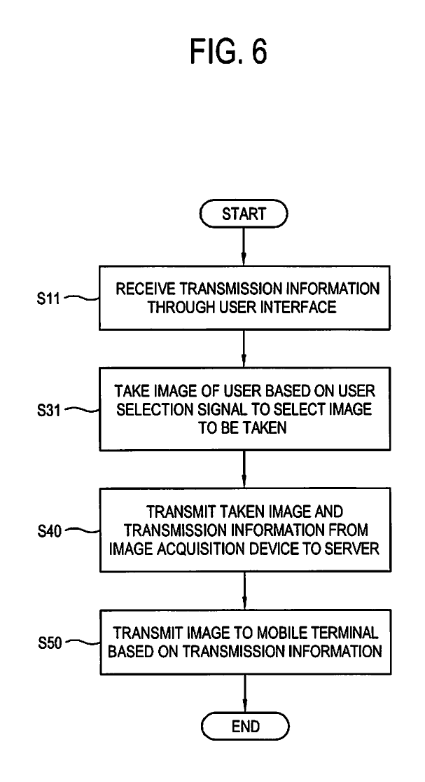

FIG. 6 is flowchart illustrating an image-providing method of the image-providing system of FIG. 4. The image-providing method according to the present embodiment will be described with reference to FIG. 6.

The image acquisition device 100 receives transmission information through the user interface 150 in step S11.

A user may input a selection signal to select an image using the user interface 150, and an image pickup unit 120 takes an image of the user based on the selection signal in step S31.

As described above, the transmission information may be received after taking the image.

The image acquisition device 100 transmits the taken image and the transmission information to the server 200 through the image pickup communication unit 130 in step S40, and the server 200 transmits the taken image to the mobile terminal 300 based on the transmission information in step S50.

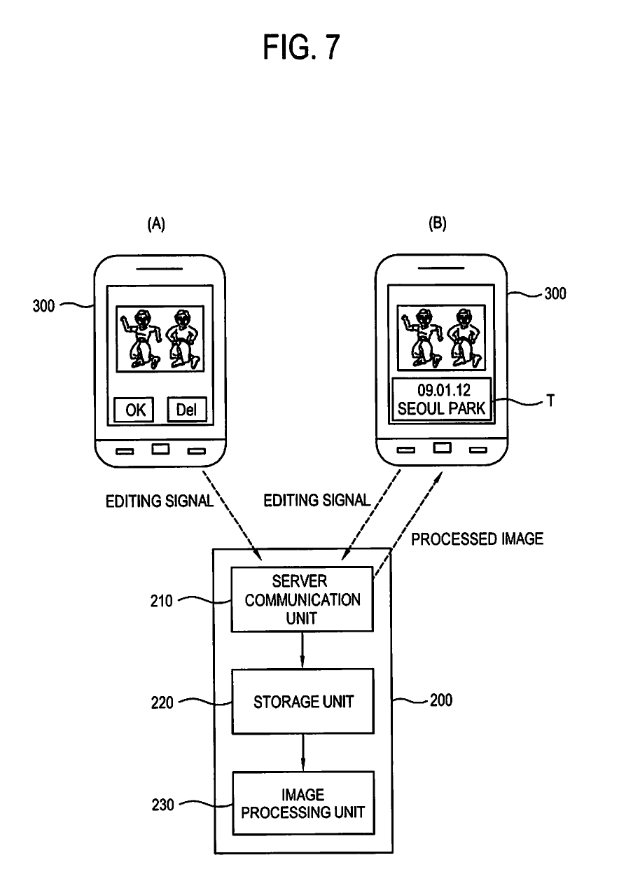

FIG. 7 is a block diagram of a server and a schematic view of a mobile terminal according to an embodiment.

The server 200 further includes an image processing unit 230 to edit a taken image. The server 200 according to the present embodiment may be applied to the image-providing system in FIGS. 1 and 4.

The server 200 may transmit information about a GUI to enable a user to edit an image when transmitting a taken image to the mobile terminal 300. The user may delete a taken image, change the resolution of an image, set a frame, add a text, adjust brightness and roughness, or apply various effects to an image using the GUI. Further, the server 200 may receive an album producing signal to make taken or changed images into an album as an editing signal from the user.

(A) shows the mobile terminal 300 displaying a GUI to enable a user to delete an image transmitted from the server 200. The user may delete an undesirable image. When an editing signal to delete an image is transmitted from the mobile terminal 300 to the server 200, the server 200 deletes the image stored in a storage unit 220.

(B) shows the mobile terminal 300 displaying an image edited by the user based on an editing signal. When the user transmits an editing signal to add a text T to an image to the server 200, the image processing unit 230 of the server 200 processes a stored image based on the editing signal and stores the processed image in the storage unit 220. The changed image may be updated to the original image. The server 200 transmits the edited image back to the mobile terminal 300 which has transmitted the editing signal. The mobile terminal 300 may provide an application to edit an image, but editing functions provided by the mobile terminal 300 are not as numerous as compared with editing functions provided by the server 200 and may be different depending on the mobile terminal 300. Thus, the server 200, according to the present embodiment, may provide editing functions, which are not available to the user's mobile terminal 300, and the user may edit an image through the server 200 as desired.

The image processing unit 230 may generate an electronic album of images modified by the user or images which are not modified. The album may include information about time and place when and where the images are taken along with the taken images and a text T added when edited by the user.

The electronic album, produced by the image processing unit 230, may be transmitted to the mobile terminal 300, a personal computer of the user, or another terminal designated by the user through a server communication unit 210.

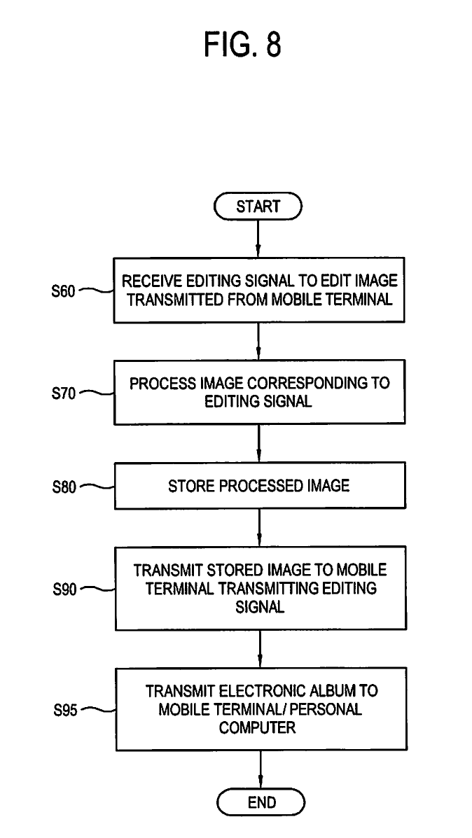

FIG. 8 is a flowchart illustrating an image-providing method of an image-providing system including the server of FIG. 7. Processes of taking images and transmitting the images to the server 200 may be performed as shown in FIGS. 3 and 6.

The server 200 receives an editing signal to edit an image transmitted from the mobile terminal 300 in step S60. The editing signal includes a signal to perform at least one of deleting an image, changing a resolution of an image, setting a frame, adding a text, adjusting brightness, changing an effect, and producing an album.

The image processing unit 230 processes an image based on the editing signal in step S70 and stores the processed image in step S80.

The server 200 then transmits the stored image to the mobile terminal 300 which has transmitted the editing signal in step S90. Since a user may re-edit the transmitted image, operations S60 to S90 may be repeated.

An electronic album produced by the image processing unit 230 is transmitted to the mobile terminal 300, a personal computer of the user, or another terminal designated by the user in step S95.

In order to make the electronic album, a user's advance setting and agreement may be needed, and the server 200 may receive an album producing signal through various paths.

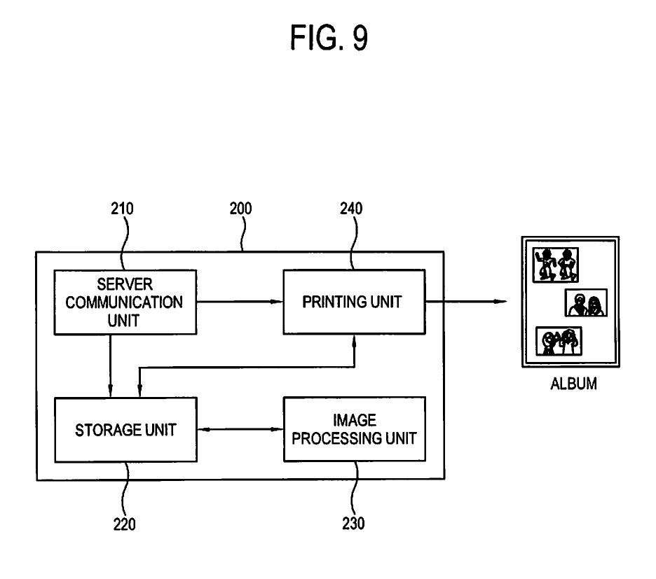

FIG. 9 is a block diagram of a server according to another embodiment of the present invention.

The server 200, according to the present embodiment, includes a printing unit 240 to print a stored image into a print, the stored image including images edited by a user or initially transmitted and an electronic album generated by the image processing unit 230 according to the above embodiment with reference to FIGS. 7 and 8. The server 200 may be applied to the image-providing system shown in FIGS. 1 and 4.

The image acquisition device 100 or the server 200 may receive an album producing request signal to develop taken images into a print such as an album from the user, and, accordingly, the print unit 240 produces an album. The album producing request signal may be received in various types. The server 200 may identify transmission of identification information to the image acquisition device 100 or registration of transmission information by the user as an album producing request signal, or identify an editing signal as an album producing request signal. The user may transmit the album producing request signal to the server 200 through a separate route from the identification information, the transmission information, and the editing signal. Further, the user may transmit a preference signal with respect to a print, along with the album producing request signal. For example, an image may be output in black and white, a paper size may be adjusted, or the type of printing paper may be selected.

The printing unit 240 may be embodies in a device physically separate from the server 200 and be installed to an exit of an amusement park. The user may input the preference signal using a user interface (not shown) included in the printing unit 240, or the mobile terminal 300 may generate the preference signal.

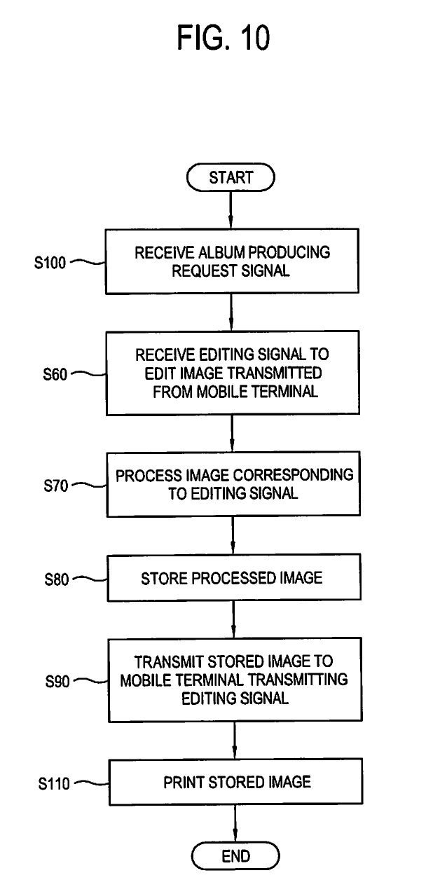

FIG. 10 is a flowchart illustrating an image-providing method of an image-providing system, including the server of FIG. 9. The server 200 receives an album producing request signal from the mobile terminal 300 in step S100. The method may further include receiving an editing signal to edit an image after the album producing request signal is received, processing an edited image, transmitting the processed image back to the mobile terminal 300 to be selected by a user in steps S60 to S90.

The printing unit 240 prints a stored image corresponding to an album producing signal in step S110. A print may be produced into an album, which the user can easily carry and keep. The user may quickly take physical possession of an album of images taken in an amusement park when leaving the amusement park.

An album producing service, which produces an album of images taken in the amusement park and provides the album when exiting, may be purchased by the user when entering the amusement park. When the user starts using the service by generating or registering identification information and transmission information, the user may be provided with developed images in an album when leaving the amusement park.

According to another embodiment, when an album producing request signal is received from a user, the server 200 does not print images but produces images into an electronic album and transmits the album to a terminal or site which the user desires. The electronic album may be forwarded to the user via email or transmitted to a blog or community.

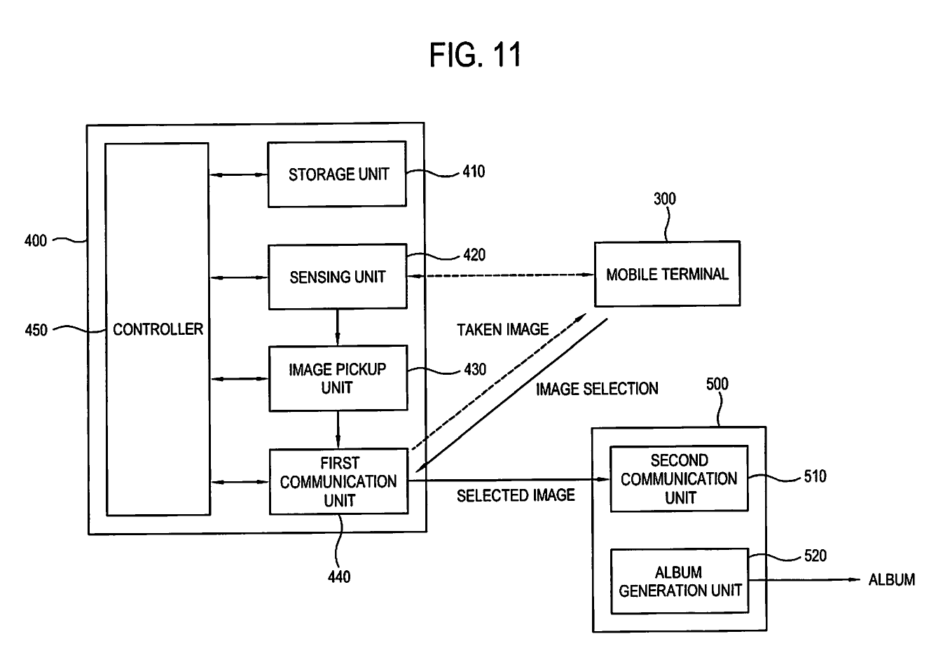

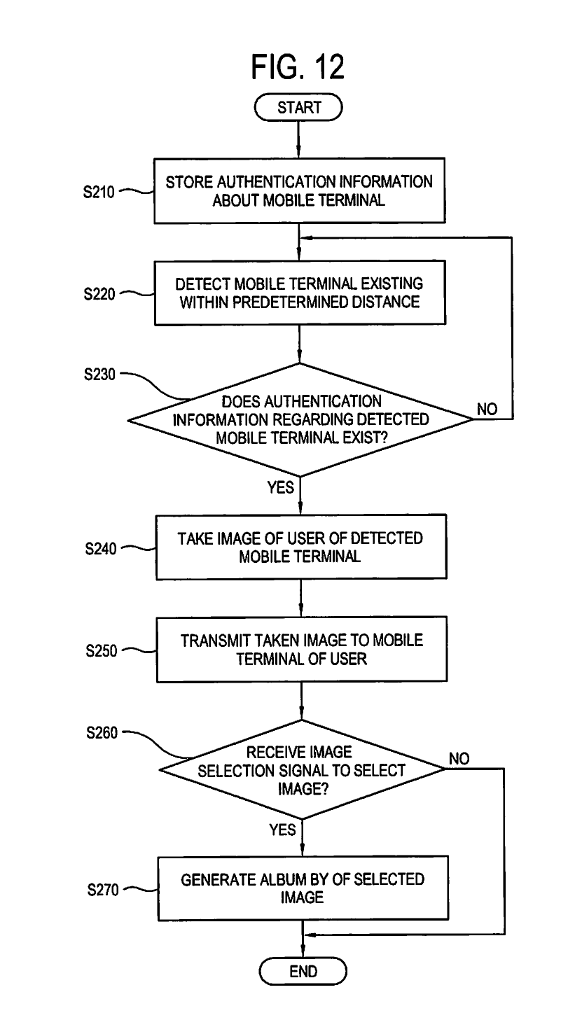

FIG. 11 is a block diagram of an image-providing system according to yet another embodiment, and FIG. 12 is a flowchart illustrating an image-providing method of the image-providing system of FIG. 11. The image-providing system, according to the present embodiment, may also take an image of a user in a limited space such as an amusement park and provide the image to the mobile terminal 300 of the user. The image-providing system includes a first device 400 and a second device 500, wherein the first device 400 includes a storage unit 410, a sensing unit 420, an image pickup unit 430, a first communication unit 440, and a controller 450, and the second device 500 includes a second communication unit 510 and an album generating unit 520.

The storage unit 410 stores authentication information of at least one mobile terminal. The authentication information is information to identify the mobile terminal and may be input through the mobile terminal and registered by the user. Further, the authentication information may be received through the second device 500 or a third device.

The sensing unit 420 detects the mobile terminal 300 when it is within a predetermined distance. The sensing unit 420 may be embodied in an RFID communication unit, or an access point or a repeater to detect a medium to communicate. Further, the sensing unit 420 may detect identification information to identify the user, not the mobile terminal 300.

The image pickup unit 430 takes an image of a user who carries the detected mobile terminal 300 or an image of the identified user. The image pickup unit 430 may include a mobile camera and a fixed camera.

The first communication unit 440 communicates with the second device 500 and transmits a taken image to the mobile terminal 300.

The controller 450 controls the above components generally and controls communication between the server 200 and the mobile terminal 300. When the mobile terminal 300 is detected, the controller 450 controls the image pickup unit 430 to take an image of the user of the detected mobile terminal 300. The controller 450 identifies authentication information about the detected mobile terminal 300, and controls the image pickup unit 430 to take an image of the user when the authentication information is identified. The controller 450 controls the first communication unit 440 to transmit the taken image to the mobile terminal 300 of the user, and to output a selected image to the second device 500 when receiving an image selection signal to select an image transmitted from the mobile terminal 300.

The second communication unit 510 of the second device 500 may receive an image or transmit information desired by the first device 500 via communication with the first communication unit 440.

The album generation unit 520 generates an album of images input through the second communication unit 510. The album generation unit 520 may further include an image processing unit to edit an image based on a user's request and an editing signal. The album generation unit 520 may generate an album by printing the input images and generate an electronic album.

The image-providing method, according to the present embodiment, will be described with reference to FIG. 12.

First, authentication information about the mobile terminal 300 is received through the first device 400 or the second device 500 and is stored in the storage unit 410 in step S210.

The sensing unit 420 of the first device 400 detects whether the mobile terminal 300 exists within a predetermined distance, that is, the mobile terminal 300 is within the predetermined distance in step S220.

The controller 450 determines whether there is authentication information about the detected mobile terminal 300 in step S230. That is, the controller 450 determines whether the detected mobile terminal 300 is registered.

As a result, when there is the authentication information about the detected mobile terminal 300, an image of the user of the detected mobile terminal 300 is taken in step S240. However, when there is no authentication information about the detected mobile terminal 300, an image is not taken but the mobile terminal 300 is detected. Operation S230 may be omitted.

The taken image is transmitted to the mobile terminal 300 of the user in step S250.

The user receiving the image may select or delete the taken image.

When an image selection signal to select an image transmitted from the mobile terminal 300 is received in step S260, the first device 400 stores the image selection signal and transmits a selected image to the second device 500.

The album generation unit 520 of the second device 500 generates an album of transmitted images in step S270. The images in the album may be edited through the user's selection, and the edited images are produced into an album. When the edited images are produced into an electronic album, the electronic album may be transmitted to the mobile terminal 300 or a personal terminal (not shown) of the user through the second communication unit 510.

The image-providing system, according to the present embodiment, includes the first device 400 to take an image and to transmit the image to the user and the second device 500 to produce images transmitted from the first device 400 into an album, thereby easily and conveniently providing an album of user's images. The image-providing system according to the present embodiment may also further include a display unit and a user interface (not shown).

Although several embodiments have been shown and described, it will be appreciated by those skilled in the art that changes may be made in these embodiments without departing from the principles and spirit of the invention, the scope of which is defined in the appended claims and their equivalents.

What is claimed is:

1. An image-providing system to provide an image to a mobile terminal, the system comprising:
at least one image acquisition device comprising an identification unit which detects identification information to identify a user and an image pickup unit which takes an image including the user corresponding to the detected identification information when the identification unit detects the identification information; and
a server which transmits the image taken by the image acquisition device to the mobile terminal based on predetermined transmission information.

2. The image-providing system according to claim 1, wherein the server transmits and receives an image through a wireless communication with the image acquisition device and the mobile terminal.

3. The image-providing system according to claim 1, wherein the image acquisition device further comprises a storage unit which stores the transmission information matching the identification information and a communication unit which transmits the taken image and the transmission information to the server.

4. The image-providing system according to claim 1, wherein the server stores the transmission information matching the identification information and transmits the taken image to the mobile terminal based on the transmission information matching the identification information.

5. The image-providing system according to claim 1, wherein the image acquisition device further comprises a communication unit which communicates with the server, and the image pickup unit takes an image of a user when transmission information matching the detected identification information is received from the server.

6. The image-providing system according to claim 4, wherein the identification information comprises terminal information to identify the mobile terminal, and the identification information is the same as the transmission information.

7. The image-providing system according to claim 4, wherein the identification unit comprises a Radio-Frequency Identification (RFID) communication unit.

8. The image-providing system according to claim 1, wherein the image acquisition device further comprises a user interface which receives a user input signal, and the transmission information is received through the user interface.

9. The image-providing system according to claim 1, wherein the image acquisition device takes an image of a user using face recognition technology.

10. The image-providing system according to claim 1, wherein the image acquisition device comprises at least one of a mobile camera and a fixed camera.

11. The image-providing system according to claim 1, wherein the image acquisition device further comprises a display unit which displays an image to be taken, and the image acquisition device further comprises a user interface which selects an image to be taken.

12. The image-providing system according to claim 1, wherein the server transmits the taken image to the mobile terminal when clarity of the taken image is more than or equal to a predetermined critical degree.

13. The image-providing system according to claim 1, wherein the server further comprises an image processing unit which processes a stored image corresponding to an editing signal when the editing signal to edit an image transmitted to the mobile terminal is received from the mobile terminal; and a storage unit which stores the processed image.

14. The image-providing system according to claim 13, wherein the editing signal comprises a signal to perform at least one of deleting an image, changing a resolution of an image, setting a frame, adding a text, adjusting brightness, changing an effect, and producing an album.

15. The image-providing system according to claim 13, wherein the server transmits the processed image by the image processing unit to at least one of the mobile terminal transmitting the editing signal and a predetermined personal terminal.

16. The image-providing system according to claim 13, wherein the server further comprises a printing unit, which prints the processed image.

17. The image-providing system according to claim 1, wherein the server further comprises a printing unit, which prints the taken image.

18. An image-providing method of an image-providing system which comprises an image acquisition device and provides an image to a mobile terminal, the method comprising:
detecting identification information to identify a user by the image acquisition device;
taking an image including the user corresponding to the detected identification information; and
transmitting the taken image to the mobile terminal based on predetermined transmission information.

19. The image-providing method according to claim 18, further comprising storing transmission information about the mobile terminal, wherein the taking the image including the user is performed when the identification information corresponds to the transmission information.

20. The image-providing method according to claim 18, further comprising storing transmission information about the mobile terminal, wherein the transmitting the image to the mobile terminal is performed when the identification information corresponds to the transmission information.

21. The image-providing method according to claim 19, wherein the identification information comprises terminal information to identify the mobile terminal.

22. The image-providing method according to claim 18, wherein the image acquisition device comprises a user interface to receive a user input signal, and the transmission information is received through the user interface.

23. The image-providing method according to claim 18, wherein the taking the image including the user uses face recognition technology.

24. The image-providing method according to claim 18, wherein the image acquisition device comprises at least one of a mobile camera and a fixed camera.

25. The image-providing method according to claim 18, wherein the image acquisition device further comprises a display unit to display an image to be taken, and the taking the image including the user comprises receiving a selection signal to select an image to be taken.

26. The image-providing method according to claim 18, wherein the transmitting the image to the mobile terminal transmits the taken image to the mobile terminal when clarity of the taken image is a predetermined critical degree or more.

27. The image-providing method according to claim 18, further comprising receiving an editing signal to edit an image transmitted to the mobile terminal from the mobile terminal;
processing the taken image corresponding to the editing signal; and
storing the processed image.

28. The image-providing method according to claim 27, wherein the editing signal comprises a signal to perform at least one of deleting an image, changing a resolution of an image, setting a frame, adding a text, adjusting brightness, changing an effect, and producing an album.

29. The image-providing method according to claim 27, further comprising transmitting the stored image to at least one of the mobile terminal transmitting the editing signal and a predetermined personal terminal.

30. The image-providing method according to claim 27, further comprising printing the stored image.

31. The image-providing method according to claim 18, further comprising printing the taken image.

32. An image-providing system, which comprises a first device and a second device and provides an image to a mobile terminal,
the first device comprising:
a storage unit which stores authentication information about at least one mobile terminal;
a sensing unit which detects a mobile terminal existing within a predetermined distance;
an image pickup unit which takes an image;
a first communication unit which transmits the taken image; and
a controller which controls the image pickup unit to take an image of a user of the detected mobile terminal, and controls the first communication unit to transmit the taken image to the mobile terminal of the user based on the authentication information and to output a selected image to the second device when an image selection signal to select the image transmitted from the mobile terminal is received, and
the second device comprising:
a second communication unit which receives the taken image; and
an album generation unit which generates an album of an image received through the second communication unit.

33. The image-providing system according to claim 32, wherein the second device further comprises an image processing unit which processes a stored image corresponding to an editing signal when the editing signal to edit an image transmitted to the mobile terminal is received from the mobile terminal, and the album generation unit generates an album by printing the processed image.

34. The image-providing system according to claim 32, wherein the second device further comprises an image processing unit which processes a stored image corresponding to an editing signal when the editing signal to edit an image transmitted to the mobile terminal is received from the mobile terminal, the album generation unit produces the processed image into an electronic album, and the second communication unit transmits the electronic album to at least one of the mobile terminal and a predetermined personal terminal.

35. The image-providing system according to claim 33, wherein the editing signal comprises a signal to perform at least one of deleting an image, changing a resolution of an image, setting a frame, adding a text, adjusting brightness, and changing an effect.

36. An image-providing method of an image-providing system which provides an image to a mobile terminal, the method comprising:
storing authentication information about the mobile terminal;
detecting a mobile terminal existing within a predetermined distance;
taking an image of a user of the detected mobile terminal;
transmitting the taken image to the mobile terminal of the user;
receiving an image selection signal to select an image transmitted from the mobile terminal; and
generating an album of the selected image based on the image selection signal.

37. The image-providing method according to claim 36, further comprising transmitting the generated album to at least one of the mobile terminal and a predetermined personal terminal.

38. The image-providing system according to claim 1, wherein the server transmits the taken image by the image acquisition device to a predetermined personal terminal.

39. The image-providing system according to claim 32, wherein the controller transmits the taken image by the image pickup unit to a predetermined personal terminal.
